(19) United States
(12) Patent Application Publication
(10) Pub. No.: US 2009/0134167 A1
(43) Pub. Date: May 28, 2009

(54) One-piece molded brake fluid reservoir

(76) Inventor: Te-San Chen, Kuan Tien Hsiang (TW)

Correspondence Address: COOPER & DUNHAM, LLP, 30 Rockefeller Plaza, 20th Floor, NEW YORK, NY, 10112, US

(21) Appl. No.: 11/998,079

(22) Filed: Nov. 28, 2007

(51) Int. Cl. B65D 1/24; G01F 23/38; H01H 36/02

(52) U.S. Cl. 220/500; 137/561 R; 200/84 C; 73/305

(57) ABSTRACT

A brake fluid reservoir for a braking system has a body and a fluid level detector. The body is hollow, single-piece molded and has a top, a bottom, two sides, a chamber, a fluid inlet and two fluid outlets. The chamber is defined in the body and has an inner surface. The fluid inlet is defined in the top and communicates with the chamber. The fluid outlets are defined respectively near the two sides in the bottom of the body and communicate with the chamber. The fluid level detector is mounted in the body and has two baffles to divide the chamber into two spaces communicating respectively with the fluid outlets. Because the body is single-piece molded, structural strength of the reservoir is enhanced.

### BACKGROUND OF THE INVENTION

1. Field of the Invention

The present invention relates to a brake fluid reservoir, and more particularly to a one-piece molded brake fluid reservoir that has an enhanced structural strength.

2. Description of Related Art

A conventional brake fluid reservoir in accordance with the prior art comprises a body with a chamber, a fluid inlet and two fluid outlets. The inlet is defined in a top of the body, and outlets are defined in a bottom respectively near two sides of the body and communicate with the chamber. A baffle is formed in the body to divide the chamber into two spaces communicating respectively with the outlets. With the spaces of the chamber, the fluid contained in the chamber is divided into two parts corresponding respectively to the outlets. Accordingly, the outlets can be prevented from being free from fluid when the vehicle is on a ramp to ensure that the fluid can be discharged from the outlets.

To form the body with the baffle of the conventional reservoir, the body is divided into a top portion and a bottom portion with two molds, and the two portions are combined together with a welding process.

However, the structural strength of the convention reservoir is only about 5 to 7 Kgw/cm² and is not enough for a high pressure condition.

To overcome the shortcomings, the present invention tends to provide a brake fluid reservoir to mitigate or obviate the aforementioned problems.

### SUMMARY OF THE INVENTION

The main objective of the invention is to provide an integral one-piece molded brake fluid reservoir that has an enhanced structural strength. The brake fluid reservoir has a body and a fluid level detecting device. The body is hollow and integrally one-piece molded and has a top, a bottom, two sides, a chamber, a fluid inlet and two fluid outlets. The chamber is defined in the body and has an inner surface. The fluid inlet is defined in the top and communicates with the chamber. The fluid outlets are defined in the bottom respectively near the two sides of the body and communicate with the chamber. The fluid level detecting device is mounted in the body and has two baffles to divide the chamber into two spaces communicating respectively with the fluid outlets.

Other objects, advantages and novel features of the invention will become more apparent from the following detailed description when taken in conjunction with the accompanying drawings.

### BRIEF DESCRIPTION OF THE DRAWINGS

FIG. 1 is a perspective view in partial section of a brake fluid reservoir in accordance with the present invention;

FIG. 2 is a side view in partial section of the brake fluid reservoir in FIG. 1;

FIG. 3 is a top view in partial section of the brake fluid reservoir in FIG. 2; and

FIG. 4 is a side view in partial section of an alternative embodiment of a brake fluid reservoir in accordance with the present invention.

### DETAILED DESCRIPTION OF PREFERRED EMBODIMENT

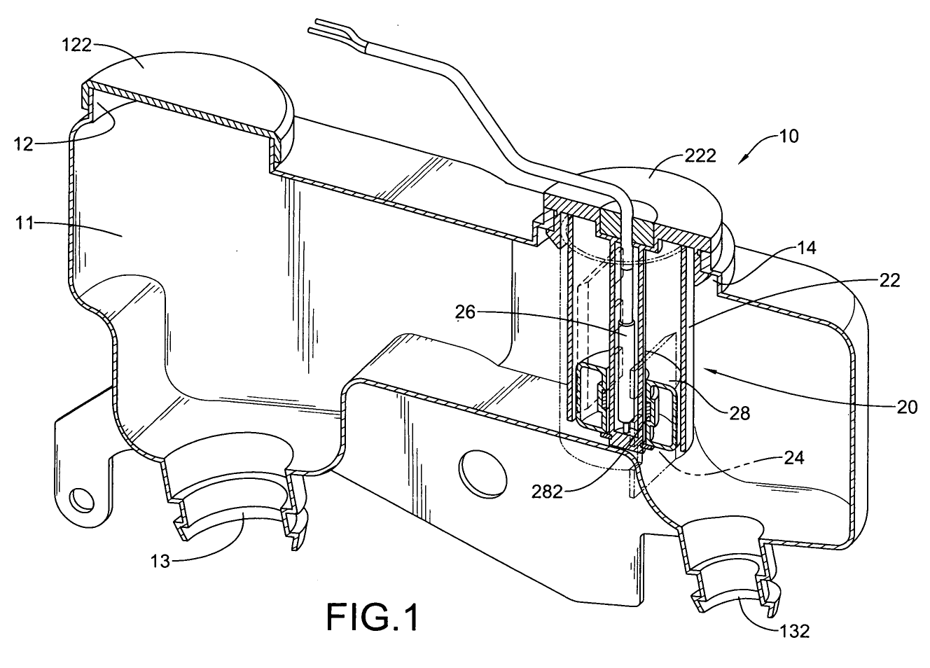

With reference to FIG. 1, a brake fluid reservoir in accordance with the present invention comprises a body (10) and a fluid level detecting device (20).

The body (10) is hollow and integrally one-piece molded and has a top, a bottom, two sides, a chamber (11), a fluid inlet (12), two fluid outlets (13,132) and a through hole (14). The chamber (11) is defined in the body (10) for containing brake fluid inside and has an inner surface. The fluid inlet (12) is defined in the top and communicates with the chamber (11) to fill brake fluid inside the chamber (11) via the inlet (12). A cap (122) is attached to and closes the fluid inlet (12). The fluid outlets (13,132) are defined in the bottom respectively near the two sides of the body (10), communicate with the chamber (11) and are connected and provide brake fluid to a brake device of a vehicle through two hoses. The through hole (14) is defined through the top of the body (10) and communicates with the chamber (11).

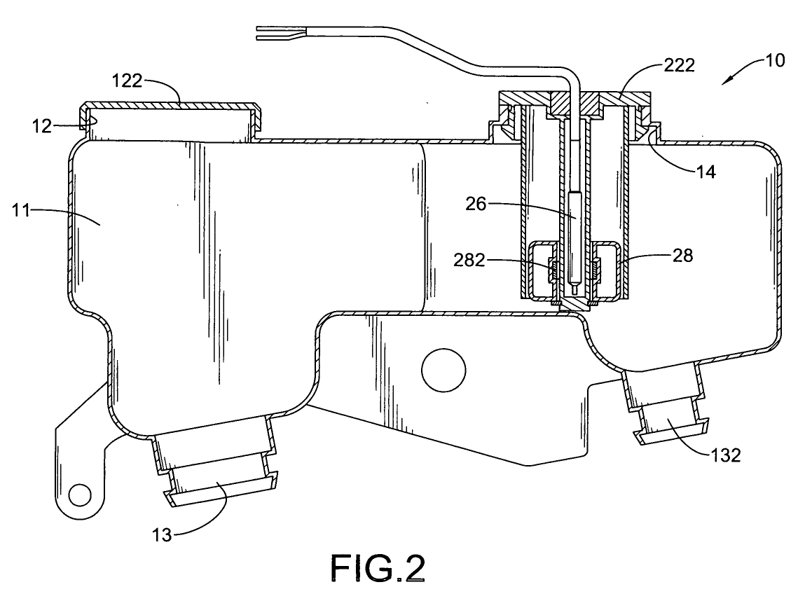

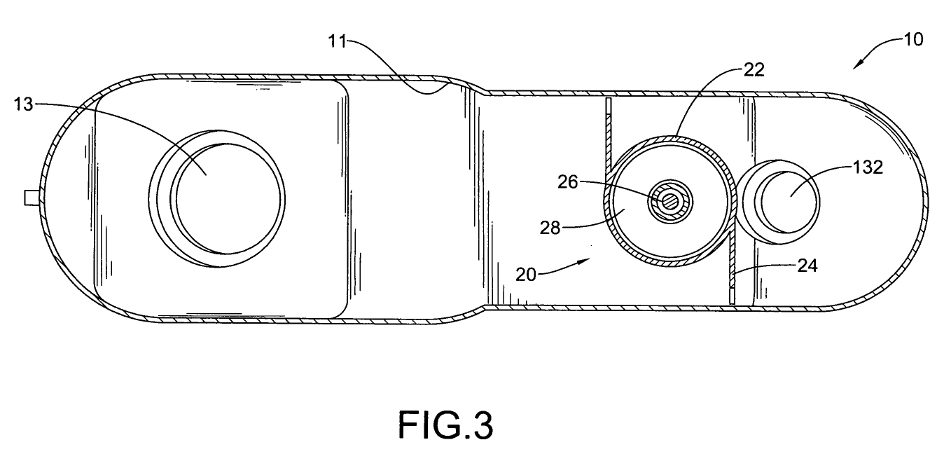

With further reference to FIGS. 2 and 3, the fluid level detecting device (20) is mounted in the chamber (11) of body (10) and has a housing (22), two baffles (24), a reed switch (26) and a floater (28). The housing (22) is hollow and mounted in the chamber (11) via the through hole (14) in the body (10) and has an axis, an outer surface, an open end and a closed end. The open end corresponds to the through hole (14) in the body (10), and a cap (222) is attached to and closes the open end. The baffles (24) are formed on and protrude from the outer surface of the housing (22), extend in opposite directions and abut the inner surface of the chamber (11) to divide the chamber (11) into two spaces communicating respectively with the fluid outlets (13,132). With the chamber (11) being divided into two spaces, the outlets (13,132) can be prevented from being free from fluid when the vehicle is on a ramp.

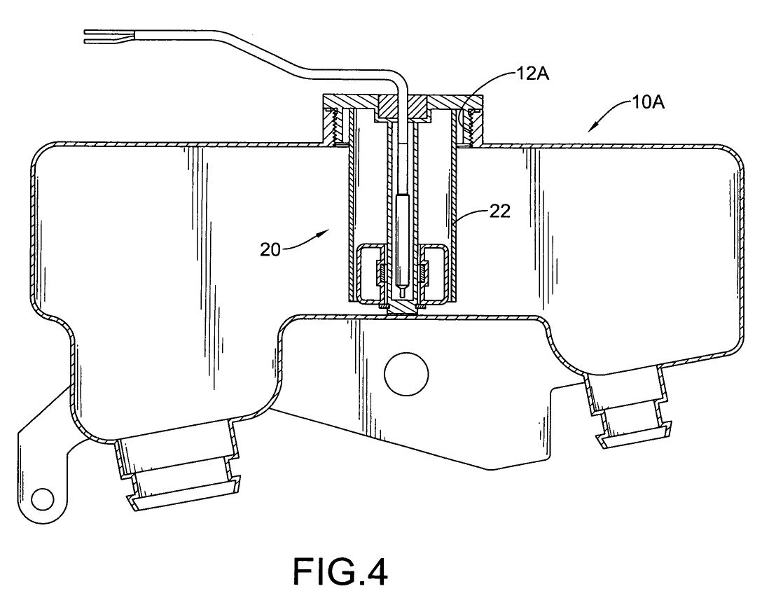

With reference to FIG. 4, in an alternative embodiment, the housing (22) of the fluid level detecting device (20) can be mounted in the fluid inlet (12A) in the body (10A), and the detecting device (20) can also serve as the cap for closing the fluid inlet (12A).

The reed switch (26) is mounted in the housing (22) along the axis of the housing (22). The floater (28) is moveably mounted in the housing (22) and around the reed switch (26) and has a magnetic element (282) mounted on the floater (28) and corresponding to the reed switch (26). The floater (28) will move up and down along the axis of the housing (22) when the fluid level in the chamber (11) changes. When the floater (28) moves downward to a predetermined lowest position, the magnetic element (282) will align with a lower point of the reed switch (26) to actuate the reed switch (26) to send a single to an alarm. The user can be informed to add brake fluid into the reservoir.

Because the body (10) is integrally one-piece molded, the structural strength of the body (10) is enhanced and may be 10 to 12 Kgw/cm². Accordingly, the brake fluid reservoir in accordance with the present invention can be applied to a high pressure condition and is versatile in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A brake fluid reservoir comprising:
an integrally one-piece molded and hollow body having
a top;
a bottom;
two sides;
a chamber being defined in the body and having an inner surface;
a fluid inlet being defined in the top and communicating with the chamber; and
two fluid outlets being defined in the bottom respectively near the two sides of the body and communicating with the chamber; and
a fluid level detecting device being mounted in the body and having two baffles to divide the chamber into two spaces communicating respectively with the fluid outlets.

2. The brake fluid reservoir as claimed in claim 1, wherein the fluid level detecting device comprises a tubular housing being mounted in the chamber of the body and having an axis and an outer surface; and
the baffles are formed on and protrude from the outer surface of the housing, extend in opposite directions and abut the inner surface of the chamber.

3. The brake fluid reservoir as claimed in claim 2, wherein the fluid level detecting device further comprises
a reed switch mounted in the housing along the axis of the housing; and
a floater moveably mounted in the housing and around the reed switch and having a magnetic element mounted on the floater and corresponding to the reed switch.

4. The brake fluid reservoir as claimed in claim 3, wherein
the body further has a through hole defined through the top of the body and communicating with the chamber; and
the housing of the fluid level detecting device is mounted in the chamber via the through hole.

5. The brake fluid reservoir as claimed in claim 3, wherein the fluid level detecting device is mounted in the fluid inlet in the body.
